(19) United States
(12) Patent Application Publication
(10) Pub. No.: US 2005/0061423 A1
(43) Pub. Date: Mar. 24, 2005

(54) Manufacturing method and manufacturing device of metal clad film

(75) Inventor: Shuichi Kohayashi, Tokyo (JP)

Correspondence Address: OLIFF & BERRIDGE, PLC, P.O. BOX 19928, ALEXANDRIA, VA, 22320, US

(73) Assignee: DOWA MINING CO., LTD., Tokyo (JP)

(21) Appl. No.: 10/915,364

(22) Filed: Aug. 11, 2004

(30) Foreign Application Priority Data
Aug. 12, 2003 (JP) 2003-292360

(51) Int. Cl. B44C 1/00; B32B 1/00

(52) U.S. Cl. 156/233; 156/344; 156/238

(57) ABSTRACT

A manufacturing method of a metal clad film capable of reducing a manufacturing cost without going through troublesome steps such as forming a carrier layer and melting and removing it. On a surface of a stainless belt-like base material 1 moving in a circulatory manner, a metal thin film 2 is formed in plating baths 24 to 25 of a metal thin film forming part 20, and in a plastic clad part 30, a plastic film layer 3 is formed on the metal thin film 2. In a peeling off part 40, a base material 1 is peeled off at a boundary surface between the base material 1 and the metal thin film 2. Whereby, the metal thin film 2 is transferred on the plastic film layer 3, and a metal clad film 5 having the metal thin film 2 on the plastic film layer 3 is obtained.

### TECHNICAL FIELD OF THE INVENTION

The present invention relates to a manufacturing method of a metal clad film used for a flexible printed circuit board, a flexible printed wiring board, or a TAB tape, etc.

### DESCRIPTION OF THE RELATED ART

A metal clad film is formed by coating a metal on a plastic film, and on the metal clad part thus formed, a circuit is formed. Then, on the circuit, a microchip such as IC (Integrated Circuit) and a condenser are packaged. Whereby, such a metal clad film becomes a required material to realize higher density packaging of electronics such as a portable telephone and a digital camera, etc.

As the metal of this kind of metal clad film, copper is most frequently used in terms of price, workability, electric property, and resistivity to migration, etc. Also, as the plastic film (insulation resin layer), serving as a film material, a polyimide film and a polyester film are used according to the purpose of use.

A manufacturing method of the metal clad film includes:

(1) A method in which a copper foil is previously prepared by rolling or electrolysis, and the copper foil is adhered to the plastic film using an adhesive.

(2) A casting method in which a precursor of the plastic film is applied on the copper foil and subjected to polymerization, thereby allowing the copper foil to be adhered to the plastic film not through an adhesive (for example, see patent Document 1).

(3) A laminate method in which a thermoplastic film is laminated so as to be overlaid on the copper foil (for example see Patent Document 1).

(4) A deposition plating method in which the plastic film is thinly covered with metal by a sputtering method, etc., and the clad metal is applied down to a specified thickness thereon by plating (for example, see Patent Document 3).

Meanwhile, in recent years, a desire for higher density package has been further increasing, and responding to a fine patterned circuit board, a request for thinner metal foil has been increasing.

However, in the method of (1) using the adhesive, in the casting method of (2), and in the laminating method of (3), a step for bonding thin materials as a copper foil is difficult in terms of handling (for example, winkles and flaws are easily occurred to the copper foil of thickness equal to or less than 9 μm, and it is hard to handle). Therefore, if the clad metal is made to be thinner, it involves a higher cost.

In addition, the deposition plating method of (4) is suitable for forming a thin metal film, but a problem is that the clad metal is weaker in adhesion to the plastic film.

Consequently, in a case of making the clad metal further thinner, by the above-described methods (1) to (3), an etching method and a method using a carrier are adopted. In the etching method, a thick copper foil is previously adhered to the plastic film, and thereafter the copper foil is made to be further thin by etching. In the method using a carrier, an electro copper plating is previously conducted on an aluminum foil (carrier) for support, thereafter the copper foil formed by plating is adhered to the plastic film using an adhesive, and then, the aluminum foil is removed.

As an example of using the carrier, Patent Document 4 shows an extremely thin copper foil with a supporting material in which a supporter layer composed of a film-llke resin, a releasable adhesive layer disposed on the supporter layer, an aluminum layer having 20 μm or less thickness formed on the adhesive layer, and an extremely thin copper foil having 2 μm or less thickness obtained by an electro-plating on the aluminum layer are laminated in this order. Also. Patent Document 4 shows an extremely thin copper foil clad film in which the extremely thin copper foil is transferred to an insulated film via an adhesive, and after mechanically releasing the supporter layer and the adhesive material layer, the aluminum layer is melted and removed.
Patent Document 1: Japanese Patent Laid Open No.60-157286
Patent Document 2: U.S. Pat. No. 4,543,295
Patent Document 3: Japanese Patent Laid Open No.61-47015
Patent Document 4 Japanese Patent Laid Open No.2002-280689

Incidentally, in the etching method in which a thick copper foil is previously adhered to the plastic film, and thereafter the copper foil is made thin by etching process, problems are that the copper foil is hard to be etched to a uniform thickness, the productivity is lowered, and a material subjected to etching process is wasted.

In addition, in the method using a carrier, the aluminum layer having 20 μm or less thickness, which is an extremely thin layer as a carrier layer, is formed, copper foil is previously formed thereon by plating, the copper foil is adhered to the plastic film, and thereafter the aluminum layer used as a carrier is melted and removed. Therefore, the problem is that the process is complicated by an amount of the process required for removing the aluminum, and a member used as a carrier, which can not be reused as it is, needs to be discarded after being peeled off, thereby involving a high cost.

### SUMMARY OF THE INVENTION

In view of the above-described circumstances, an object of the present invention is to provide a manufacturing method and a manufacturing device of a metal clad film capable of making a clad metal laminated on an insulation resin layer extremely thin without wasting a material associated with an etching process, and capable of reducing a manufacturing cost without going through a troublesome step such as melting and removing an aluminum later.

In order to solve the above-described problems, the present invention provides features described below.

A first feature provides a manufacturing method of the metal clad films comprising the steps of:
forming a metal thin film on the surface of a base material;
forming an insulation resin layer on the metal thin film; and
transferring the metal thin film on the insulation resin layer by peeling off the base material at a boundary surface between the base material and the metal thin film,
and by executing the steps in this order, a metal clad film having the metal thin film on the insulation resin layer is obtained.

A second feature provides the manufacturing method of the metal clad film according to the first feature, comprising the steps of:
forming at least an outermost layer of the base material with any one of the elements selected from stainless, Ti, or an alloy containing Ti as a main component;
forming the metal thin film composed of copper or a copper-alloy on the outermost layer by plating; and
enabling the base material to be peeled off from the metal thin film by making a peel strength of a boundary surface between the base material and the metal thin film smaller than the peel strength of the boundary surface between the metal thin film and the insulation resin layer.

A third feature provides the manufacturing method of the metal clad film according to the first feature, comprising the steps of:
by using polyimide and fluorocarbon resin or using a material whose surface is coated with these resins as the base material, forming the metal thin film composed of copper or a copper alloy on the surface by using any one of the thin film forming processes selected from an electroless plating process, a vapor deposition process, and a liquid phase growth process, or by using the thin film forming processes obtained by combining at least above-described two methods;
thereby making a peel strength of a boundary surface between the base material and the metal thin film smaller than a peel strength of a boundary surface between the metal thin film and the insulation resin layer; and
thus allowing the base material to be peeled off from the metal thin film.

A fourth feature provides the manufacturing method of the metal clad film according to any one of the first to third features, wherein a roughened surface is formed on the metal thin film before executing the second step in order to improve peel strength between the metal thin film and the insulation resin layer.

A fifth feature provides the manufacturing method of the metal clad film according to any one of the first to fourth features, wherein by using the base material peeled off in the third step, the first to third steps are executed in the next manufacture again, thereby continuously manufacturing the metal clad film.

A sixth feature provides the manufacturing method according to the fifth feature, comprising the steps of:
forming the base material as an endless belt so as to be rotated and driven on a specified circulating course in a constant direction;
executing the first step at a first position on the circulating course;
executing the second step at a second position on the downstream side lower than the first position; and
executing the third step at a third position on the downstream side lower than the second position.

A seventh feature provides the manufacturing method of the metal clad film according to any one of the first to sixth features, comprising the steps of:
coating a precursor of the insulation resin layer on the metal thin film in the second step;
after drying the precursor of the insulation resin layer thus coated, curing it by heating; and
thereby forming the insulation resin layer on the metal thin film.

An eighth feature provides the manufacturing method of the metal clad film according to any one of the first to sixth features, comprising the steps of:
laminating the insulation resin layer on the metal thin film in the second step;
subjecting the insulation resin layer thus laminated to a heating treatment; and
thereby forming the insulation resin layer on the metal thin film.

A ninth feature provides a manufacturing device of a metal clad film, comprising:
a metal clad part forming a metal thin film on a surface of a base material;
a resin clad part forming an insulation resin layer on the metal thin film; and
a peeling off part transferring the metal thin film on the insulation resin layer by peeling off the base material at a boundary surface between the base material and the metal thin film.

A tenth feature provides the manufacturing device of the metal clad film according to ninth feature, comprising:
a circulating track for moving the base material formed as an endless belt along a specified circulating course;
a first position, a second position, and a third position respectively set on the circulating track from the upstream side to the downstream side in a moving direction of the base material;
the metal clad part at the first position;
the resin clad part at the second position; and
the peeling off part at the third position.

According to the first aspect of the present invention, a metal thin film is formed on a surface of a base material in a first step;
an insulation resin layer is formed on the metal thin film in a second step;
the metal thin film is transferred on the insulation resin layer by peeling off the base material at a boundary surface between the base material and the metal thin film,
and therefore the metal clad film having an extremely thin clad metal can be obtained without wrinkles or flaws occurred to the metal thin film. In addition, the metal thin film can be formed into an extremely thin film from the start, thereby eliminating the step of decreasing the thickness of the metal thin film later by etching and wasting the material. Also, the base material is directly peeled off at the boundary surface between the base material and the metal thin film, thereby eliminating a troublesome step in which an aluminum layer is melted and removed later as shown in Patent Document 4. Accordingly, it becomes possible to manufacture the metal clad film coated with an extremely thin metal, at a low cost with good productivity.

According to the second aspect of the present invention, the outermost surface of the base material is formed of any one of the elements selected from stainless, Ti, or an alloy containing Ti as a main component, and the outermost surface is plated with the metal thin film composed of copper or a copper alloy, therefore, the base material can be easily peeled off at a boundary surface between the base material and the metal thin film, and the base material can be reused as it is without waste.

According to the third aspect of the present invention, polyimide-resin and fluorocarbon resin, or the material whose surface is coated with these resins are used as the insulation resin layer, and the metal thin film composed of copper or a copper alloy is formed on the surface by using any one of the thin film forming processes selected from an electroless plating process, a vapor deposition process, and a liquid phase growth process, or by using the thin film forming processes obtained by combining at least above-described two methods, and therefore the base material is easily peeled off at a boundary surface between the base material and the metal thin film, and the base material can be reused as it is without waste.

According to the fourth aspect of the present invention, a roughened surface is formed on the metal thin film before executing the second step, and therefore peel strength between the insulation resin layer and the metal thin film can be further improved.

According to the fifth aspect of the present invention, by using the base material peeled off in the third step, the first to third steps in the next manufacture can be executed again, thereby continuously manufacturing the metal clad film, and therefore the cost of the base material can be suppressed at minimum.

According to the sixth aspect of the present invention, the base material is formed as an endless belt so as to be rotated and driven on a specified circulating course in a constant direction, and on the circulating course, the first step is executed at the first position, the second step is executed at the second position on the downstream side lower than the first position, and the third stop is executed at the third position on the downstream side lower than the second position, and therefore a system for manufacturing the metal clad film while effectively reusing the base material can be structured.

According to the seventh aspect of the present invention, a precursor of the insulation resin layer is applied on the metal thin film, and after drying it, the precursor is cured by heating, thereby forming the insulation resin layer on the metal thin film. Therefore without using an adhesive, the metal clad film with strong peel strength between the metal thin film and the insulation resin layer can be easily manufactured.

According to the eighth aspect of the present invention, the insulation resin layer is provided by lamination on the metal thin film and subjected to a heating treatment, and therefore without using an adhesive, the metal clad film with strong peel strength between the metal thin film and the insulation resin layer can be easily manufactured.

According to the ninth aspect of the present invention, after the metal thin film is formed on the surface of the base material, the insulation resin layer is formed on the metal thin film, and further, by peeling off the base material at the boundary surface between the base material and the metal thin film, the metal thin film is transferred on the insulation resin layer, and therefore without wrinkles or flaws occurred to the metal thin film, the metal clad film having an extremely thin clad metal can be obtained.

According to the tenth aspect of the present invention, the base material is formed as an endless belt and rotated and driven on the specified circulating course in a constant direction, and on the circulating course, the first step is executed at the first position, the second step is executed at the second position on the downstream side lower than the first position, and the third step is executed at the third position on the downstream side lower than the second position, and therefore the metal clad film can be manufactured while effectively reusing the base material.

### BRIEF DESCRIPTION OF THE DRAWINGS

FIG. 1 is an explanatory view of a manufacturing method of a metal clad film according to a first embodiment of the present invention.

FIG. 2 is an explanatory view of a manufacturing method of the metal clad film according to a second embodiment of the present invention.

FIG. 3 is a view showing an example of the case of one side clad metal, as a modified example of FIG. 2.

### DESCRIPTION OF THE PREFERRED EMBODIMENTS

Preferred embodiments of the present invention will be explained hereafter.

A manufacturing method of a metal clad film of the embodiments of the present invention comprises the steps of:
forming a metal thin film on a surface of a base material which can be substantially used plural times;
forming an insulation resin (plastic film) layer on the metal thin film; and
transferring the metal thin film on the insulation resin layer by peeling off the base material at a boundary surface between the base material and the metal thin film, and by executing the above steps in this order, the metal clad film having the metal thin film on the insulation resin layer is manufactured.

As a process for forming (coating) the metal thin film on the base material, a plating process is a most excellent process in terms of cost. However, any technique including various other processes such as a vapor deposition process and a liquid phase growth process, etc., may be used. Moreover, as a material of the metal thin film, copper or phosphor bronze comprising copper as a main phase, and an oxidation resistant alloy such as brass are preferably used in terms of cost and workability.

As the base material from which the metal thin film can be peeled off, stainless and Ti, or an alloy containing Ti as a main component are preferably used in a case of forming the metal thin film by electro-plating. In such a case, at least an outermost surface (part to be plated) of the base material may be formed of the above-described metals. By using the base material thus obtained, the peel strength of the boundary surface between the base material and the metal thin film can be made smaller than the peel strength of the boundary surface between the metal thin film and the insulation resin layer. Thus, it becomes possible to peel off the base material from the metal thin film in the third step.

In addition to this, when forming the metal thin film by an electroless plating process, a vapor deposition process, and a liquid phase growth process, polyimide-resin and fluorocarbon resin, or the above resin-clad various metals and resin-composition can be used as the insulation resin layer. In such a case, according to the selected base material, the peel strength of the boundary surface between the base material and the metal thin film can be made smaller than the peel strength of the boundary surface between the metal thin film and the insulation resin layer. Thus, it becomes possible to peel off the base material from the metal thin film in the third step.

Moreover, in order to obtain a strong peel strength between the metal thin film and the insulation resin layer formed thereon, the surface of the metal thin film is preferably roughened. As the surface roughening treatment, it is most preferable to subject the surface of a flat and smooth metal thin film to a burned plating that performs quick plating at high current density. In addition to this, the surface roughening treatment also includes mechanical polishing, coating, drying, and baking of a metal paste material.

When the surface of the metal thin film is subjected to the surface roughening treatment, it may be plated by using copper or phosphor bronze comprising copper as a main phase, and an oxidation resistant alloy such as brass. However, it may also preferably be plated by using Cr, Ni, Mo, W, V, Ti, Si, Fe, Al, or an alloy containing them as main components. By plating using metals such as Cr, Ni. Ho, or the alloy, the reactivity of the metal thin film to a polyamic acid, which is a precursor of polyimide, is suppressed, and dispersing of impurity metal ion into a polyimide film is suppressed, and therefore the strong peel strength between the metal thin film and the polyimide film is improved, and also mechanical characteristics of the polyimide film itself can be improved.

If the surface roughness of the surface subjected to the surface roughening treatment is set so as to become a mean square roughness (Rms) of 0.05 μm or more, a bare minimum peel strength as a metal clad film can be secured. However, for specified usage in which a high reliability is required for bending characteristics such as a bending part of a cellular phone, and in a case where thermally stable strong peel strength of 1.0 N/mm² or more is required to be obtained in a peel test as will be described later, the mean square roughness (Rms) is preferably set to be 0.1 μm or more.

As the plastic film becoming the insulation resin layer, a polyimide film excellent in mechanical strength, heat resistivity, and chemical resistivity is most preferable. Moreover, to use for which the heat resistivity is not required, a polyester film is preferable.

As a process for forming the polyimide film on the metal thin film, it is preferable that polyamic acid as a precursor of the polyimide is previously formed and applied on the metal thin film, and subjected to a dehydrative oyclization reaction, so as to be formed into a film.

It is preferable to prepare the precursor of the polyimide film by firstly mixing a diamine component into a polymerization solvent, next, adding thereto tetracarboxylic acid dianhydride in almost the same molarity, and allowing them to be reacted in an organic solvent.

As the tetracarboxylic acid dianhydrid, for example, pyromellitic dianhydride, oxydiphthalic dianhydride, biphenyl-3,4,3′,4′-tetracarboxylic acid dianhydrid, biphenyl-2,3,3′,4′-tetracarboxylic acid dianhydrid, benzophenon-3,4,3′,4′-tetracarboxylic acid dianhydrid, diphenyl sulfone-3,4,3′,4′-tetracarboxylic acid dianhydrid, 4,4-(2,2-hexafluoroisopropylidene) diphthalic dianhydride, m (p)-terphenyl-3,4,3′,4′-tetracarboxylic acid dianhydrid, cyclobutane-1,2,3,4-tetracarboxylic acid dianhydrid, 1-carboxymethyl-2,3,5-cyclopentanecarbosylic acid-2,6: 3,5-dianhydride, 2,2-bis(3,4-dicarboxyphenyl) propane dianhydride, bis(3,4-dicarboxyphenyl) ether dianhydride, bis(3,4-dicarboxyphenyl) sulfone dianhydride, 2,3,6,7-naphthalene tetracarboxylic acid dianhydride, etc., and at least two kinds of mixture selected from them are preferably used, however it is not limited thereto.

Also, as the diamine component, for example, an aromatic diamine such as 1,4-diaminobenzene, 1,3-diaminobenzene, 2,4 diaminotoluene, 4,4′-diaminodiphenylmethane, 4,4′-diaminodiphenyl ether, 3,4′-diaminodiphenyl ether, 3,3′-dimethyl-4,4′-diamino biphenyl, 2,2′-dimethyl-4,4′-diamino biphenyl, 2,2′-bis(trifluoromethyl)-4,4′-diaminobiphenyl, 3,7-dimethyldibenzothiophene-5,5-dioxide, 4,4′-diaminobenzophenone, 3,3′-diaminobenzophenone, 4,4′-bis(4-aminophenyl) sulfide, 4,4′-bis(4-aminophenyl) diphenylmethane, 4,4′-bis(4-aminophenyl) diphenylether, 4,4′-bis(4-aminophenyl) diphenylsulfone, 4,4′-bis(4 -aminophenyl) diphenylsulfide, 4,4′ bis(4-aminophenoxy) diphenylether, 4,4′-bis(4-aminophenoxy) diphenylsulfone, 4,4′-bis(4-aminophenoxy) diphenylsulfide, 4,4′-bis. (4-aminophenoxy) diphenylmethane, 4,4′-diaminodiphenylsulfone, 4,4′-diaminodiphenylsulfide, 4,4′-diaminobenzanilides, 1, n -bis(4-aminophenoxy) alkane (n=3,4,5), 1,3-bis(0,4-aminophenoxy)-2,2-dimethyl propane, 1,2-bis[2-(4-aminophenoxy) ethoxy] ethane, 9,9-bis(4-aminophenyl) fluorine, 5 (6)-amino-1-(4-aminomethyl)-1,3,3-trimethylindene, 1,4-bis(4-aminophenoxy) benzene, 1,3-bis(4-aminophenoxy) benzene, 1,3-bis(3-aminophenoxy) benzene, 4,4′-bis(4-aminophenoxy) biphenyl, 4,4′-bis(3-aminophenoxy) biphenyl, 2,2-bis(4-aminophenoxyphenyl) propane, 2,2-bis(4-aminophenyl) propane, bis[4-(4-aminophenoxy) phenyl] sulfone, bis[4-(3-aminophenoxy) phenyl] sulfone, 2,2-bis[4-(aminophenoxy) phenyl] propane, 2,2-bis[4-(4-aminophenoxy) phenyl] hexafluoropropane, 3,3′-dicarboxylate-4,4-diaminodiphenyl methane, 4,6-dihydroxy-1,3-phenylene diamine, 3,3′-dihydroxy-4,4′-diaminobiphenyls, 3,3′ 4.4′-tetraaminobiphenyl, 1-amino-3-aminomethyl-3,5,5-trimethylcyclohexane, 1,3-bis(3-aminopropyl)-1,1,3,3-tetramethyldisiloxanes 1,4-diaminobutane, 1,6-diaminohexane, 1,8-diaminooctane, 1,10-diaminodecane, 1,12-diaminodecane 2,2′-dimethoxy-4,4′-diaminobenzanilides, 2-methoxy-4.4′-diaminobenzanilides, an aliphatic diamine, and a xylylene diamine, etc., and mixture of two kinds or more selected from them are preferably used, however it is not limited thereto.

As the organic solvent which can be used for manufacturing the polyamic acid, for example, N-methyl-2-pyrrolidone, N,N-dimethylformamide, N,N-dimethylacetamide, N,N-diethylacetamide, dimethylaulfoxide, hexamethyl-phosphor amide, N-methylcaprolactam, cresol, etc., can be preferably used. Above-described organic solvents may be used alone, or two kinds or more of them may be used by mixing, however it is not limited thereto.

In addition, as a ring closing agent that adjusts molecular weight, dicarboxylic acid anhydride and two kinds or more of dicarbosylic acid anhydrides or aliphatic tertiary amines such as trimethylamine, triethylamine; etc., and heterocyclic tertiary amines such as isoquinoline, pyridine, betapicoline, etc., and more than two kinds of the mixture of the aliphatic tertiary amines and the heterocyclic tertiary amines can be used, however it is not limited thereto.

In addition, in the metal clad film according to the present invention, the ratio of the difference between the metal clad film and the plastic film in linear expansion coefficient is set to be ±40% or less, thereby reducing the curl of the plastic film at the time of metal coating and a stress induced when the metal clad film is heated or cooled. Therefore, thermal stability of the metal clad film can preferably be improved. As an example of the combination of the metal film and the plastic film, for example, when the metal film is copper, since the copper has the linear expansion coefficient of 16.6×10⁻⁶/K in 300 K, it is desirable to select the plastic film having the linear expansion coefficient of 10 to 23×10⁻⁶/X.

Further, by selecting the plastic film having tensile elastic modulus of 1000 MPa or more, the metal clad film having high reliability can be obtained.

The combination of the diamine components and tetracarboxylic acid dianhydride suitable for manufacturing the plastic film having the tensile elastic modulus of 1000 MPa or more and the linear expansion coefficient of 10 to 23×10⁻⁶/K, for example, includes biphenyl-3,4,3′,4′-tetracarboxylic dianhydride as tetracarboxylic acid dianhydride, and diamine component containing 1,4-diaminobenzene as a main component. Diamine component and tetracarboxylic acid dianhydride are preferably ≧50% concentration distribution range in each component, and the other component can be replaced with one or more kinds of diamine component and tetracarboxylic acid dianhydride.

Also, if desired, a polymic acid is firstly applied onto a base material and dried to prepare a gel film having a self-supporting property. Next, the film is subjected to a specified extension process by fixing its end and extending vertically and horizontally. Thus, the linear expansion coefficient of this film can be made close to the linear expansion coefficient of the clad metal. Note that when performing this process, first the gel film is prepared on a smooth base material of 0.02 μm or less in square surface roughness (Rms), and the gel film thus formed is peeled off and subjected to an extension process, and thereafter pressed onto the base material whose surface is roughened to perform imidation by using a catalyst process and/or a heating process.

Moreover, in order to improve the peel strength between the metal clad film and the plastic film, a thermoplastic film is laminated on the metal clad film as an adhesion layer, and the plastic film having the linear expansion coefficient close to the clad metal is laminated thereon. Then, with pressing if necessary, and by using the catalyst process and/or the heating process, the thermoplastic film is adhered to the metal clad film.

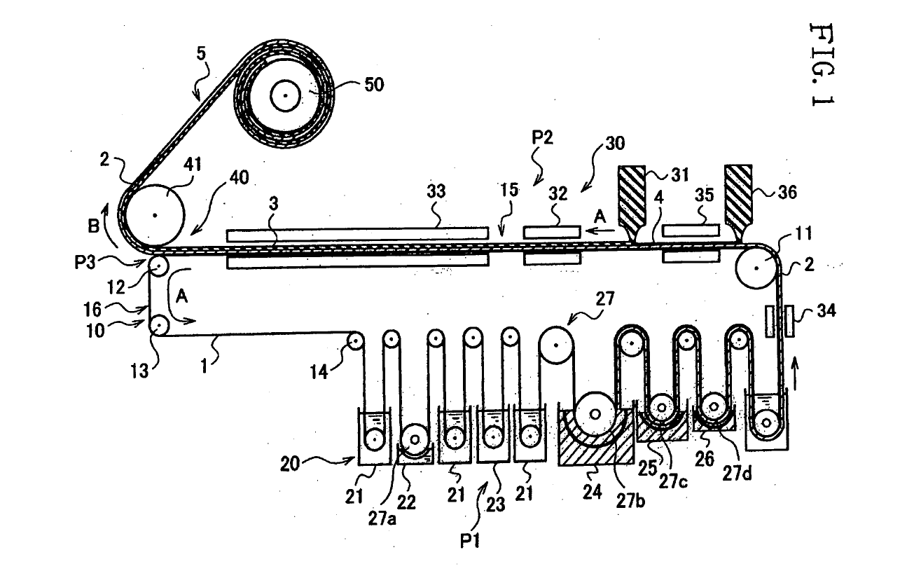

Next, a specific manufacturing method of the metal clad film will be explained with reference to FIG. 1. FIG. 1 is a view schematically showing the equipment for attaining a method of the embodiment. In the figure, designation mark 1 indicates a base material, mark 2 indicates a metal thin film formed on the base material, mark 3 indicates a plastic film layer (insulation resin layer) formed on the metal thin film, mark 4 indicates an adhesive plastic film layer by which the metal thin film and the plastic film layer formed thereon are adhered to each other, and mark 5 indicates a metal clad film manufactured by this equipment.

Mark 10 indicates a circulating track (circulating course) for circulating a base material 1 formed as an endless belt in a direction shown by an arrow A, and a plurality of rollers 11 to 14 are provided at required places for forming the track. A linear part 15 of prescribed length is provided on the circulating track 10, and on the downstream end of the linear part 15, a turning part 16 that turns in a direction apart from an extended line of the linear part 15 is provided. In addition, in a course range from the turning part 16 to the upper stream end of the linear part 15, a metal thin film forming part 20 is provided.

The metal thin film forming part 20 is a part for executing the first step (metal coating process) in which the metal thin film (copper thin film) having prescribed thickness is continuously formed on the surface of the base material 1 by electro-plating, and the metal thin film forming part 20 is provided at a first position P1 on the circulating track 10.

The metal thin film forming part 20 has a prescribed number of cleaning baths 21 for water rinsing the base material 1, an electrolytic degreasing bath 22, a pickling bath 23, a first smooth plating bath 24, a roughening plating bath 25, a second smooth plating bath 26, and rollers 27 (27a to 27d) for sequentially dipping the base material 1 into each bath.

By passing through the metal thin film forming part 20, a metal thin film 2 having a prescribed thickness is formed on one surface of the base material 1.

A base material drying and heating processing part 34 is provided between the first position P1 where the first step (metal coating step) is executed, and the second position P2 on the downstream side, so as to dry the base material 1 and the metal thin film 2.

In addition, in the linear part 15 corresponding to the second position P2 on the downstream side lower than the first position P1 where the first step (metal coating step) is executed, a plastic clad part 30 for executing the second step (plastic coating step) is provided. The plastic clad part 30 is a part where the plastic film layer (insulation resin layer) 3 is formed on the metal thin film 2 of the base material 1 that moves in a direction shown by an arrow A on the linear part 15, a first coating part 36 coating a precursor of the adhesive plastic film layer on the metal thin film 2 is provided on the upper stream end, and on the downstream side, a first drying and heating process part 35 is provided. In addition, on further downstream side of the first drying and heating process part 35, a second coating part 31 is provided. In the second coating part 31, the precursor of the plastic film is applied on the adhesive plastic precursor layer applied on the metal thin film 2. On the downstream side of the second coating part 31, a second drying and heating process part 32 is provided, and on the further downstream side, a heating and curing part 33 is provided.

On the metal thin film 2 on the base material 1 dried in the base material drying and heating process part 34, the precursor of the adhesive plastic film is applied at the first coating part 36, and the precursor becomes an adhesive plastic film layer 4 by passing through the first drying and heating process part 35. Next, in the second coating part 31, on the adhesive plastic film layer 4, the precursor of the plastic film is applied, and the precursor becomes the plastic film layer 3 by passing through the second drying and heating process part 32. Laminates of the base material 1, metal thin film 2, adhesive plastic film layer 4, and plastic film layer 3 that pass through the second drying and heating process part 32, are heated in the heating and curing part 33, and the adhesive plastic film layer 4 and the plastic film layer 3 are thereby cured, to become a laminate of the metal thin film 2 and the plastic film layer 3 adhered to each other through the mediation of the adhesive plastic film.

Thus, by passing through the plastic clad part 30, the plastic film layer 3 is formed on the metal thin film 2 on the base material 1.

On the downstream side of the second position P2 where the second step (plastic coating step) is executed, that is, at third position P3, located on the downstream end of the linear part 15 in the circulating track 10 of the base material 1, a peeling off part 40 for executing a third step (peeling off step) is provided. In the peeling off part 40, by peeling off the base material 1 at a boundary surface between the base material and the metal thin film 2, the metal thin film 2 is transferred on the plastic film layer 3. The peeling off part 40 is arranged on the downstream end of the linear part 15, and formed of a turning roller 41 for guiding the plastic film layer 3 in a direction (in a direction shown by an arrow B in the figure) apart from the extended line of the linear part 15 to the opposite side of the base material 1.

By this peeling off part 40, the metal thin film 2 of the position apart from the base material 1 is transferred on the plastic film layer 3, and a metal clad film 5 is formed. Then, the metal clad film 5 is wound-up to a wind-up roller 50.

When manufacturing the metal clad film 5 using the equipment thus structured, the circulating track 10 is driven to circulate the base material 1 in a direction shown by an arrow A. Then, when the base material 1 passes through the metal thin film forming part 20, the base material 1 is water-rinsed in the cleaning bath 21, degreased in the electrolytic degreasing bath 22, pickled in the pickling bath 23, and sequentially passed through the first smooth plating bath 24, the roughening plating bath 25, and the second smooth plating bath 26. Thus, the metal thin film 2 is formed on the surface of the base material 1.

Subsequently, when the base material 1 passes through the plastic clad part 30, the precursor of the adhesive plastic film is firstly applied on the metal thin film 2 of the base material 1 by the coating part 36 on the upper stream end, and dried in the second drying and heating process part 35. Thus, an adhesive plastic film layer is formed. Next, by the coating part 31, the precursor of the plastic film is applied on the adhesive plastic film layer, and the precursor is dried in the second drying and heating process part 32. Thus, a plastic film layer is formed. Then, the adhesive plastic film layer and the plastic film layer on the metal thin film 2 are heated and cured in the heating and curing part 33, so as to be formed into a film. Then, at the exist of the downstream end of the linear part 15, by the action of the turning roller 41 and the roller 12 on the circulating track 10 side, the base material 1 is peeled off from the metal thin film 2 at the boundary surface between the base material 1 and the metal thin film 2, and the base material 1 is guided to the circulating track 10 side, and the plastic film layer 3 with the metal thin film 2 adhered thereto is guided to the wind-up roller 50 side. Thus, while continuously reusing the base material 1, the metal clad film 5 can be continuously manufactured.

As described above, the metal thin film 2 is laminated on the plastic film layer 3 with the metal thin film 2 supported by the base material 1. Therefore, the metal clad film 5 having an extremely thin clad metal 2 can be obtained without wrinkles or flaws occurred to the metal thin film 2. In addition, the metal thin film 2 can be made to be an extremely thin by plating from the start. Therefore, it is possible to eliminate the step of wasting the material such as decreasing the thickness of the metal thin film 2 later by etching process.

Moreover, the base material 1 is directly peeled off in the boundary surface between the base material 1 and the metal thin film 2, and therefore as shown in Patent Document 4, it is not necessary to interpose an aluminum layer between the metal thin film 2 and the base material 1, thereby eliminating a troublesome step of melting and removing the aluminum layer later. In addition, the base material 1 is reused as it is, it becomes possible to manufacture the plastic film having an extremely thin clad metal thereon, at a low cost with good productivity.

Incidentally, in the above-described embodiment, it was shown that the precursor of the adhesive plastic film and the precursor of the plastic film are sequentially applied on the metal thin film 2, and by passing through the drying and heating process step (first and second drying and heating process parts 35 and 32) and the heating and curing step (heating and curing part 33), the plastic film provided with the metal thin film was integrally laminated. Of course, as a modified example of the embodiment, it is also preferable to be so structured that as a precursor of the plastic film, the precursor of the plastic film having both adhesiveness and a prescribed substrate characteristic is used, and the adhesive plastic film is omitted, or it is also preferable to be so structured that the precursors of these films are replaced with the plastic films for adhesion and/or substrate, or the plastic films having both characteristics (including the film available in the market).

As an embodiment different from the above-described manufacturing method of the plastic film, it is preferable to provide on the metal thin film an adhesion layer formed of an adhesive plastic precursor or the adhesive plastic film, and next, on the adhesion layer, the plastic film precursor or the plastic film is disposed by lamination, then, these are subjected to a prescribed drying and/or heating process as needed, and thereafter, heated and laminated. Thus, the plastic film layer is formed on the metal thin film.

When the above-described plastic film forming method is adopted, it is preferable that a thermoplastic resin is used as the adhesion layer, and the plastic film is laid thereon in the order, and in this state, a heating and laminating treatment is applied.

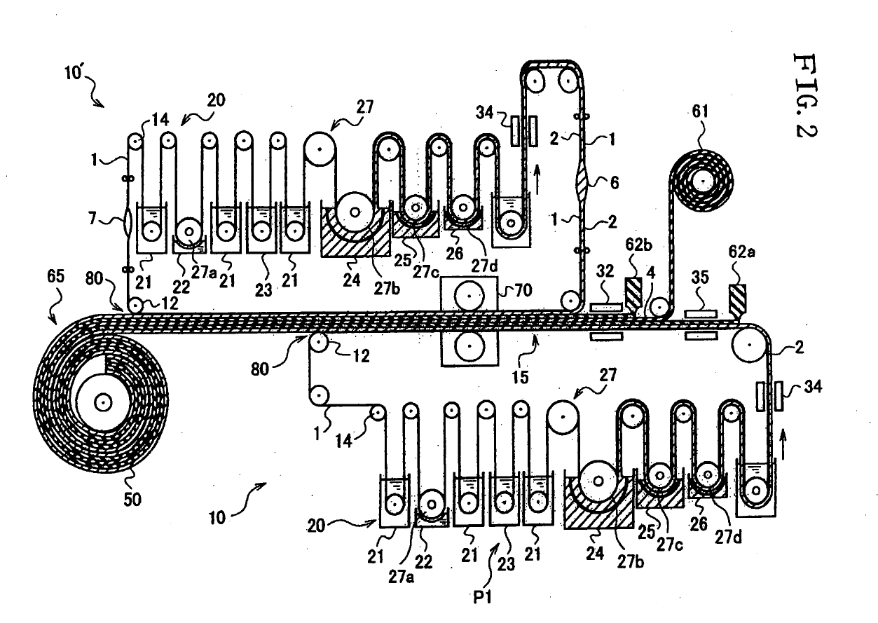

FIG. 2 is a view showing the modified example of the device for attaining the method of the embodiment.

The device shown in FIG. 2 has almost the same structure as the device shown in FIG. 1. However, FIG. 2 shows an example of the device for obtaining the metal clad film having metal thin films on both sides of the plastic film by using the plastic film from the start, not by forming the plastic film from the plastic film precursor.

In this device, two circulating tracks 10 of the base material 1 having the same structure as described in FIG. 1 are provided, and the metal thin film 2 is formed on each surface of the two base materials 1. In FIG. 2, the circulating track of the two circulating tracks 10, located in the lower part of the linear part 15 is indicated by designation mark 10, and the circulating track located in the upper part is indicated by designation mark 10′. The circulating tracks 10 and 10′ have almost the same structure. However, the circulating track 10′ has an inversion part 6 for inverting the front and rear sides of the base material 1 plated with the metal thin film 2, and an inversion part 7 for re-inverting the front and rear sides of the base material 1 peeled off from a metal clad film 65. Then, the linear parts 15 of the circulating tracks 10 and 10′ are respectively made to face with each other as the parts where the heating and laminating step is executed, and a heating and laminating device 70 is arranged in this part.

Then, from an upper stream end of the linear part 15, in a first adhesive plastic precursor clad part 62a, the first adhesive plastic precursor is applied on the metal thin film 2 of the circulating track 10, so that the first adhesive plastic precursor is formed into an adhesive plastic layer in the first drying and heating process part 35. On the adhesive plastic layer, a plastic film 61 is disposed, and in a second adhesive plastic precursor clad part 62b this time, the second adhesive plastic precursor is applied on the plastic film 61, so that the second adhesive plastic film precursor is formed into an adhesive plastic layer in the second drying and heating process part 32. The metal thin film 2 plated on the base material 1 is transferred from the circulating track 10′ on the layer which is formed into an adhesive plastic layer in the second drying and heating process part 32. At this time, the linear part 15 is made to be a multi-layer structure of the base material 1, the metal thin film 2, the adhesive plastic layer, the plastic film 61, the adhesive plastic layer, the metal thin film 2, and the base material from the above. Next, the multi-layer structure is subjected to a laminating process by receiving a heating and pressing process by a heating and laminating device 70, thus forming a multi-layer structure of an integrated combination of the base material 1, the metal thin film 2, the plastic film 61, the metal thin film 2, and the base material 1, from the above.

When the base material 1, the metal thin film 2, and the plastic film 61 thus laminated pass through a peeling off part 80 (formed of each roller 12 of the circulating tracks 10 and 10′) located on the downstream end of the linear part 15, each base material 1 is peeled off from the metal thin film 2 when each base material 1 is guided in a direction mutually apart from the extended line of the linear part 15, and the plastic film 61 with the metal thin films 2 adhered on both sides, is led out along the extended line of the linear part 15, and a metal clad film 65 whose both surfaces are coated is thereby obtained.

As described above, in an example shown in FIG. 2, the circulating tracks 10 and 10′ are arranged so as to be located at the upper and lower positions of the linear part 15. However, they can also be arranged at right and left positions.

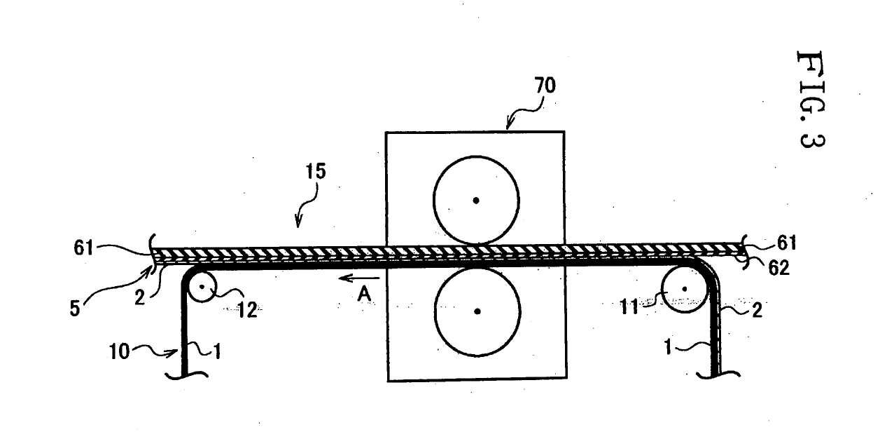

In addition, in an example shown in FIG. 2, explanation was given to a case where the metal thin films 2 are laminated on both surfaces of the plastic film 61, and the metal clad film 65 whose both surfaces are coated is thereby obtained. However, as shown in FIG. 3, the metal thin film 2 may be laminated on only one surface of the plastic film 61, and similarly to the example of FIG. 1, the metal clad film 5 whose one surface is coated may be obtained. In such a case, the circulating track 10 of the base material 1 of one side can be omitted, and the adhesive plastic precursor to be arranged on the surface of the plastic film 61 may be interposed on only the surface on which the metal thin film 2 is transferred.

With the above-described structure, the base material which can be reused substantially plural times is extended up to an insulation resin forming step and an adhesion step of the clad metal and the insulation resin layer. Whereby the metal clad film having an extremely thin clad metal can be obtained without wrinkles or flaws occurred to the metal thin film. Further, the troublesome step such as adjusting a carrier layer and melting and removing the carrier layer is eliminated, and therefore it became possible to manufacture an extremely thin metal clad film with high quality at a low cost.

Moreover, as described above, the base material formed as an endless belt was exemplified as a most preferable embodiment of the present invention. However, it is not limited thereto. A plate material having a prescribed dimension is selected as the base material, and by using the plate-like base material, the plating process step, the resin forming step, and the peeling off step, etc., may be executed as a batch type continuous process step. In this case also, the base material is reusable.

Next, specific embodiments of a manufacturing method will be explained.

(Embodiment 1)

As a base material 1 which can be peeled off from the clad metal, a belt-like stainless having 40 mm width and 0.15 mm thickness was used and a metal clad film was manufactured by using equipment shown in FIGS. 1 and 3. When manufacturing the metal clad film, as will be described next, cleaning of the base material, metal coating (narrowly-defined plating step), plastic film coating, peeling off, and winding-up were conducted.

(1) Cleaning of the Base Material

Water rinsing, degreasing, water rinsing, pickling, and water rinsing were conducted in this order by dipping the belt-like stainless (base material 1) into each bath of a bath composition as described below.

| | |
|---|---|
| Water rinsing: | Ion-exchanged water having a resistivity |
| | of 10⁶ Ωcm or above |
| Electrolytic degrease: | Voltage 5 V |
| Pickling: | Dilute sulfuric acid aqueous solution |
| | of 20% sulfuric acid concentration |

(2) Metal Coating Step

Baths of two kinds of bath composition for smooth plating and roughening plating as described below were prepared, and the belt-like stainless (base material 1) was dipped into a first smooth plating bath 24, a roughening plating bath 25, a second smooth plating bath 26 in this order, and processed under each condition. Thus, a copper thin film (metal thin film 2) having a roughened surface of Ni plating is formed on a copper-plating layer, with 5 μm thickness.

| | |
|---|---|
| Smooth plating bath 24: | A copper sulfate plating bath BMP-CUS, |
| | produced by World Metal Corporation |
| | Current density 2 A/dm² |
| Roughening plating bath: | Nickel sulfamate (50 g/L Ni content) |
| | Nickel chloride (15 g/L Ni content) |
| | Boric acid (30 g/L) |
| | Current density 40 A/dm² |
| Second smooth plating bath | Nickel sulfamate (100 g/L Ni |
| 26: | content) |
| | Nickel chloride (15 g/L Ni |
| | content) |
| | Boric acid (30 g/L) |
| | Current density 5 A/dm² |

(3) A Manufacturing Method of a Polyimide Precursor as an Adhesive Plastic Precursor

In a nitrogen current, 292 g of 1,3-bis(3-aminophenoxy) benzene and 294 g of biphenyl-3,4,3′ 4′-tetracarboxylic acid dianhydride were added into 1850 g of N,N-dimethylacetamide in a polymerizer and stirred up. Next, 11.8 g of hydrophthalic anhydrides was added and further stirred up, to prepare a polyamide acid solution as a polyamide precursor.

(4) A Method for Coating a Polyimide Film

On the surface of the copper clad film prepared in (2), the polyamide acid solution prepared in (3) was applied and flow-cast, thereafter dried with hot air of 140° C., subsequently subjected to temperature-raise gradually until 330° C. and maintained for 10 minutes, then down to room temperature, thus forming an adhesive plastic layer. On the adhesive plastic layer, the polyimide film having the thickness of 25 μm (Upilex-S produced by UBE INDUSTRIES) was provided by lamination, and thereafter through laminating by using a heating roll at the temperature of 300° C. under the linear pressure of 10 kg·f/cm, the polyimide film was provided on the surface of the copper clad film.

(5) Peeling Off and Winding-Up Method

The stainless belt was peeled off from the three layer structure such as the polimide film, the copper clad film, and the stainless belt explained in (4). The peeling-off was conducted at the boundary surface between the copper clad film and the stainless belt (base material 1), and the copper clad polyimide film was sequentially wound-up as shown in FIG. 1. Meanwhile, the stainless belt was fed to the step of (1), and continuously roused.

(6) Visual Inspection

A test sample having the width of 40 mm, length of 6240 mm was cut out from the copper clad polyimide film manufactured as described above, and the occurrence of a dent and a pin hole was evaluated by eye observation. As a result, there was no occurrence of the pin hole of 0.1 mm or more and the dent having maximum diameter of 1 mm or more.

(7) Evaluation of Peel Strength

Since the strength of the copper foil is required in a peeling-off test used for evaluation, the test sample having the width of 2 cm and length of 10 cm was cut out randomly from the copper-clad polyimide film manufactured as described above, and then the evaluation of peel strength was conducted by re-plating the copper foil until its thickness becomes 30 μm. The test was conducted after heating the sample at 180° C. according to the peeling-off test in 90° direction of JISC6471. As a result, extremely high peel strength of 1.0 to 1.3 N/mm² could be obtained.

As the base material from which the clad metal can be peeled off, a stainless plate having the width of 10 cm, length of 15 cm, and thickness of 1 mm was used, and the copper-clad polyimide film was manufactured by sequentially passing through the cleaning step, the metal coating step, the plastic coating step, and the peeling-off step.

(1) Cleaning of Base Material

Water rinsing, degreasing, water rinsing, pickling, and water rinsing were conducted in this order by dipping the stainless plate having the width of 10 cm, length of 15 cm, and thickness of 1 mm into each bath of the bath composition as described below.

| | |
|---|---|
| Water rinsing: | Ion-exchanged water having a resistivity |
| | of 10⁶ Ωcm or above |
| Electrolytic degrease: | Voltage 5 V |
| Pickling: | Dilute sulfuric acid aqueous solution |
| | of 20% sulfuric acid concentration |

(2) Metal Coating Step

The stainless plate (base material) was dipped into a plating bath (sequentially dipped into the first smooth plating bath, the roughening plating bath, the second smooth plating bath) of the same bath composition as described in (2) of the embodiment 1, and further processed under a prescribed condition. Whereby the copper thin film having a Ni-plated roughened surface on the copper plating layer was applied on the stainless plate (base material), with 5 μm thickness. An electrode was fixed to the upper part of the stainless plate by a clip, and as a negative electrode, a platinum clad Ti was parallely arranged in the bath.

(3) Manufacturing Method of a Plyimide Precursor as an Adhesive Plastic Precursor

In a nitrogen current, 292 g of 1,3-bis(3-aminophenoxy) benzene and 294 g of biphenyl-3,4,3′,4′-tetracarboxylic acid dianhydride were added into 1850 g of N. N-dimethylacetamide in a polymerizer and stirred up. Next, 11.8 g of hydrophthalic anhydride was added and further stirred up, to prepare a polyamide acid solution as a polyamide precursor.

(4) Method for Coating a Polyimide Film

On the surface of the copper clad film prepared in (2), the polyamide acid solution prepared in (3) was applied and flow-cast, thereafter dried with hot air of 140° C., subsequently subjected to temperature-raise gradually until 330° C. and maintained for 10 minutes, then down to room temperature, and an adhesive plastic layer is thereby formed. On the adhesive plastic layer, the polyimide film having the thickness of 25 μm (Upilex-S produced by UBE INDUSTRIES) was provided by lamination, and thereafter through laminating by using a heating roll at the temperature of 300° C. under the linear pressure of 10 kg f/cm, the polyimide film was provided on the surface of the copper clad film.

(5) Peeling Off Method

The stainless belt was peeled off from the copper clad film on which the polyimide film prepared in (4) was provided. The peeling-off was conducted at the boundary surface between the copper clad film and the stainless plate, and the copper clad polyimide film was thereby prepared. Meanwhile, the stainless plate was fed to the step of (1), and continuously reused.

(6) Visual Inspection

A test sample having the width of 100 mm, length of 150 mm was cut out from the copper clad polyimide film manufactured as described above, and the occurrence of a dent and a pin hole was evaluated by eye observation. As a result, there was no occurrence of the pin hole of 0.1 mm or more and the dent having maximum diameter of 1 mm or more.

(7) Evaluation of Peel Strength

Since the strength of the copper foil is required in a peeling-off test used for evaluation, the test sample having the width of 2 cm and length of 10 cm was cut out randomly from the copper-clad polyimide film manufactured as described above, and the evaluation of the peel strength was conducted by re-plating the copper foil until its thickness becomes 30 μm. The test was conducted after heating the sample at 180° C. according to the peeling-off test in 90° direction of JISC6471. As a result, extremely high peel strength of 1.0 to 1.3 N/mm² could be obtained.

### COMPARATIVE EXAMPLE

A comparative example was prepared under the following condition and evaluated to compare with the embodiment.

Specifically, after step (2) of the embodiment 2, the copper foil was peeled off from the base material (stainless plate), and set on another base material. Then, from stop (3) to step (4) of the embodiment 2 were executed, and the copper clad polyimide film was thereby manufactured. Next, in the same way as steps (6) and (7) of the embodiment 2, the visual inspection and the evaluation of the peel strength were conducted. As a result, in the visual inspection, an indefinitely large number of pinholes of 0.1 mm or more and an indefinitely large number of dents having the maximum diameter of 1 mm or more were observed. In addition, regarding the evaluation of the peel strength, the peel strength was set low to be 0.4 to 0.9 N/mm², and the strength was dispersed.

1. A manufacturing method of a metal clad film, comprising:
a first step of forming a metal thin film on a surface of a base material;
a second step of forming an insulation resin layer on the metal thin film; and
a third step of transferring the metal thin film on the insulation resin layer by peeling off the base material at a boundary surface between the metal thin film and the base material,
wherein by executing the steps in this order, a metal clad film having the metal thin film on the insulation resin layer is obtained.

2. The manufacturing method of the metal clad film according to claim 1, wherein at least an outermost layer of the base material is formed of any one of the elements selected from stainless, Ti, or an alloy containing Ti as a main component, and the metal thin film containing copper or a copper-alloy is formed on the outermost layer by plating, thereby making a peel strength of a boundary surface between the base material and the metal thin film smaller than the peel strength of the boundary surface between the metal thin film and the insulation resin layer, to allow the base material to be peeled off from the metal thin film.

3. The manufacturing method of the metal clad film according to claim 1, comprising:
by using polyimide and fluorocarbon resin or using a material whose surface is coated with these resins as the base material, forming the metal thin film composed of copper or a copper alloy on the surface by using any one of the thin film forming processes selected from an electroless plating process, a vapor deposition process, and a liquid phase growth process, or by using the thin film forming processes obtained by combining at least above-described two processes;
thereby making a peel strength of a boundary surface between the base material and the metal thin film smaller than a peel strength of a boundary surface between the metal thin film and the insulation resin layer;
thus allowing the base material to be peeled off from the metal thin film.

4. The manufacturing method of the metal clad film according to claim 1, wherein a roughened surface is formed on the metal thin film before the second step is executed in order to improve strong peel strength between the metal thin film and the insulation resin layer.

5. The manufacturing method of the metal clad film according to claim 1, wherein by using the base material peeled off in the third step, the first to third steps are executed in the next manufacture again, thereby continuously manufacturing the metal clad film.

6. The manufacturing method according to claim 5, comprising:
the first step of forming the base material as an endless belt so as to be rotated and driven on a specified circulating course in a constant direction;
the second step of executing the first step at a first position on the circulating course;
the third step of executing the second step at a second position on the downstream side lower than the first position; and
the fourth step of executing the third step at a third position on the downstream side lower than the second position.

7. The manufacturing method of the metal clad film according to claim 1, comprising:
coating a precursor of the insulation resin layer on the metal thin film in the second step;
after drying the precursor thus coated, curing it by heating; and
thereby forming the insulation resin layer on the metal thin film.

8. The manufacturing method of the metal clad film according to claim 1, comprising:
laminating the insulation resin layer on the metal thin film in the second step;
subjecting the insulation resin layer thus laminated to a heating treatment; and
thereby forming the insulation resin layer on the metal thin film.

9. A manufacturing device of a metal clad film, comprising:
a metal clad part forming a metal thin film on a surface of a base material;
a resin clad part forming an insulation resin layer on the metal thin film; and
a peeling off part transferring the metal thin film on the insulation resin layer by peeling off the base material at a boundary surface between the base material and the metal thin film.

10. The manufacturing device of the metal clad film according to claim 9, comprising:
a circulating track on which the base material formed as an endless belt is moved along a specified circulating course;
a first position, a second position, and a third position respectively set on the circulating track from the upstream side to the downstream side in a moving direction of the base material;
the metal clad part at the first position;
the resin clad part at the second position; and
the peeling off part at the third position.
